(19) United States
(12) Patent Application Publication
(10) Pub. No.: US 2023/0299371 A1
(43) Pub. Date: Sep. 21, 2023

(54) Method for the prelithiation of a silicon-containing anode in a lithium-ion battery

(71) Applicant: Wacker Chemie AG, Munich (DE)

(72) Inventor: Stefan Haufe, Neubiberg (DE)

(73) Assignee: Wacker Chemie AG, Munich (DE)

(21) Appl. No.: 18/018,588

(22) PCT Filed: Jun. 17, 2021
(86) PCT No.: PCT/EP2021/066415

§ 371 Date: Jan. 30, 2023

(51) Int. Cl. H01M 10/44; H01M 10/0525; H01M 4/38; H01M 4/134

(52) U.S. Cl. CPC H01M 10/446; H01M 10/0525; H01M 4/386; H01M 4/134; H01M 2004/027

(57) ABSTRACT

A lithium-ion battery and a method for pre-lithiating a silicon-containing anode for use therein. The method includes providing a lithium-ion battery including a cathode having a lithium transition metal oxide, an anode, a separator, and an organic electrolyte. Where the end voltage during a battery charging cycle procedure U1 is between 4.35 V and 4.80 V. During subsequent battery charging cycles, the end voltage during discharging of the battery U2 does not drop below 3.01 V and where during subsequent battery charging cycles, the end voltage during charging of the lithium-ion battery U3 is lower than the end voltage during charging of the lithium-ion battery U1. The lithium-ion battery is charged by the cc/cv method and the end voltage during subsequent discharging of the lithium-ion battery U4 is lower than the end voltage during discharging of the lithium-ion battery U2 and does not drop below 3.01 V.

The invention relates to a method for prelithiating a silicon-containing anode in a lithium-ion battery by applying defined voltages during a charging procedure and during subsequent cycling of the battery, and also to a lithium-ion battery producible by the method.

Rechargeable lithium-ion batteries are now the practical electrochemical energy stores featuring the highest gravimetric energy densities, of up to 250 Wh/kg, for example. A widespread active material for the negative electrode (anode) is graphitic carbon. The electrochemical capacity of graphite, however, is limited to at most 372 mAh/g. Graphite-based anodes of the high-energy lithium-ion batteries nowadays have volumetric electrode capacities of at most 650 mAh/cm³. An alternative anode active material recommended, with higher electrochemical capacity is silicon. Silicon forms binary electrochemically active alloys with lithium, of the formula Li₄₄Si, corresponding to a specific capacity of 4200 mAh per gram of silicon. During incorporation and extraction of lithium, unfortunately, silicon undergoes a change in volume of up to 300%. Over the course of a number of charging and discharging cycles, this results in a continuous, generally irreversible loss of battery capacity, which is also referred to as fading. A further problem lies in the reactivity of silicon. Hence on contact with the electrolyte, passivating layers are formed on the silicon surface (solid electrolyte interface; SEI) with immobilization of lithium, which reduces the capacity of the battery. An SEI is formed during the first-time charging of silicon-containing lithium-ion batteries, resulting in initial capacity losses. On further operation of the lithium-ion batteries, volume changes on the part of the silicon particles occur during each charging and discharging cycle, resulting in fresh silicon surfaces being exposed, which in turn react with constituents of the electrolyte and form further SEIs in the process. This leads to immobilization of further lithium and hence to a continuous, irreversible loss of capacity.

Anodes containing silicon particles are known from EP1730800, for example. Typical further constituents of such anodes are binders and oftentimes graphite or conductivity additives. A variety of approaches have been described for reducing continuous, irreversible capacity losses in lithium-ion batteries. For example, WO 2017/025346 recommends operating lithium-ion batteries such that in the fully charged state of the battery, the silicon of the anode is only partially lithiated, and so the capacity of the silicon for lithium is not entirely exhausted. US 2005/0214646 charges batteries such that the molar lithium/silicon ratios in the anode material are 4.0 at most. In concrete terms, Li/Si ratios of 3.5 and higher are described.

A variety of specifications disclose the use of prelithiated silicon as an active anode material for lithium-ion batteries. Prelithiation refers generally to the measure whereby lithium is introduced into the active anode material before the operation of the lithium-ion battery, and this lithium, in the course of battery discharge, is not extracted, or at least not extracted entirely, from the anode. Prelithiation of active silicon material may be accomplished, for example, by milling elemental lithium with silicon in a ball mill or in the melt, in which case silicide phases may be formed, as described by Tang et al., J. Electrochem. Soc. 2013, 160, 1232-1240. DE 102013014627 describes prelithiation methods in which Si particles are reacted with inorganic lithium compounds, such as lithium oxides, or with organic lithium compounds, such as lithium salts of carboxylic acids. In US 2014212755, inorganic lithium compounds, such as oxides, halides or sulfides, are introduced into the cathode. In that case the active anode material is prelithiated as part of the formation of the battery. An analogous approach is described in U.S. Pat. No. 10,115,998 as well. DE 102015217809 describes lithiating active anode materials by means of chemical vapor deposition (CVD process) using lithiated precursors, such as lithiated alkynes or lithiated aromatic hydrocarbons, and then coating them with carbon. According to WO 2018/112801, lithium peroxide is introduced as a chemically reactive sacrificial salt into the cathode or the electrolyte, and on formation of the battery is broken down, with accompanying prelithiation of the anode. In US 20150364795 as well, an electrolyte is employed that comprises lithium salts, such as lithium azides, lithium acetates, lithium-amines or lithium-acetylenes. Here as well, prelithiation of the active anode material takes place during formation of the battery. The formation may be accomplished, for example, at voltages of 3.8 to 5 volts, more particularly 4.2 to 5 volts. WO 2016/089811 recommends various metals as active anode materials, especially silicon alloys. The prelithiation of the active anode materials takes place in the half-cell against lithium. US 2016141596 prelithiates active anode material by applying elemental lithium in the form of a thin lithium foil to the current collector. WO 2017/123443 A1 employs stabilized lithium metal powder (SLMP FMC Lithium Energy) to prelithiate the anode. Examples of SLMP are lithium metal particles coated with lithium salt for passivation. Compacting such anodes causes the passivation layer of the SLMP to rupture, allowing the lithium particles to participate in the redox process in the cell and to prelithiate the active anode material. SLMP, however, is very expensive and sensitive to atmospheric humidity, and is therefore not compatible with water-based processing of the active anode material to the electrode. The lithium-ion batteries of US 2018/0358616 also contain anodes with prelithiated silicon. In US 2018/0358616, the batteries are cycled with full utilization of the specific anode capacity of the silicon-containing anodes. Active anode materials identified in that case are silicon particles having average diameters of 30 to 500 nm. The amount of mobile lithium (sum total of lithium from the cathode and lithium introduced by prelithiation) which is available for intercalation and extraction processes was established as being 1.1 to 2.0 times the amount of lithium in the cathode. The anode coatings of US 2018/0358616 contain 20 wt % of silicon. Detractions from capacity when the batteries are cycled occur to an increased extent, however, in the case of anodes having relatively large silicon fractions.

WO 2020/233799 describes a lithium-ion battery where the anode comprises prelithiated silicon and the anode material of the fully charged lithium-ion battery is only partially lithiated, with the overall degree of lithiation α of the silicon being 10 to 75%, based on the maximum lithiation capacity of silicon.

For all of the aforesaid prelithiation methods, it is the case that materials and cell components and/or manufacturing operations have to be greatly modified in order to introduce additional lithium for the prelithiation of the silicon-containing anode coating. The mass additionally introduced, moreover, is deleterious to the energy content of the lithium-ion cell.

The object was to provide a prelithiation method for a battery cell with Si-containing anode material that does not require any adaptation or modification to the cell production process but at the same time enables a high reversible capacity and a high cycle stability.

A subject of the invention is a method for prelithiating a silicon-containing anode in a lithium-ion battery, comprising a cathode of lithium transition metal oxide, an anode, a separator, and an organic electrolyte, wherein
1) the end voltage during a battery charging procedure (U1) is between 4.35 V and 4.80 V,
2) during subsequent battery cycling, the end voltage during discharging of the battery (U2) does not drop below 3.01 V, and
3) during subsequent battery cycling, the end voltage during charging of the battery (U3) is lower than the end voltage during charging of the battery (U1).

Surprisingly it has been found that in lithium-ion cells with a silicon-containing anode (partial lithiation), a cathode comprising lithium transition metal oxide, and an organic electrolyte, the combination of high cycle stability with high discharge capacity is achieved on compliance with the end voltages defined according to the invention. The cycle stability is increased by comparison with a battery of the same construction operated according to conventional methods if the prelithiation method of the invention is employed, i.e., if the end voltages defined according to the invention are complied with. This also significantly reduces the fading and the continuous losses during cycling. A particular surprise is the effect of the end voltage during charging of the battery (U1), which is increased by comparison with the prior art, especially with WO 2020/233799.

The charging capacity during the first charging procedure with increased end voltage (U1) of the battery (Q_{L,Z1}) is increased by comparison with a battery having the same construction but operated according to customary methods. Because the discharge capacity during discharging of the battery (Q_{L,Z1}) is controlled by the end voltage during discharging of the battery (U2) such that it is situated within the customary bounds, there is a greater charge remaining in the negative electrode (prelithiation). During the subsequent charging of the battery (Q_{L,Z2}), the charge capacity is preferably lower than or the same as that of a battery with the same construction but operated according to customary methods.

It is self-evident that U2 is smaller than U1.

The end voltage during charging of the battery (U3) on subsequent cycling is preferably greater than U2 and less than U1. The difference between U1 and U3 is preferably between 0.05 V and 0.50 V.

U1 is preferably between 4.37 V and 4.70 V and especially preferably between 4.40 V and 4.60 V.

U2 is preferably between 3.02 V and 3.30 V and, especially preferably for C-rates<C/5, preferably between 3.30 V and 3.10 V, and for C-rates>C/5 is between 3.02 V and 3.20 V.

The C-rate refers to the charging or discharging current relative to the nominal capacity of the battery. 1 C denotes complete charging or discharging in one hour, and C/5, analogously, means complete charging or discharging in 5 hours.

The method of the invention is preferably part of the formation of the battery, and is preferably also employed during cycling. In particular, during the subsequent cycling of the battery, the end voltage during second discharging (after increased end voltage during charging (U1)) of the battery (U4) is lower than the end voltage during first discharging of the battery (U2). U4 is situated preferably between 3.00 V and 3.20 V and especially preferably between 3.01 V and 3.15 V.

Lithiation of silicon refers generally to the introduction of lithium into silicon. In this case, generally, silicon-lithium alloys are formed, also known as lithium silicides.

Prelithiation of silicon generally represents a lithiation of silicon before or during the formation of the lithium-ion battery, with the amount of lithium introduced into the silicon accordingly remaining entirely or at least partially in the silicon during the cycling of the lithium-ion battery. Expressed in other words, prelithiation denotes, generally, the lithiation of silicon before the lithium-ion battery is cycled between the voltage limits U3 and U2 or U4. Lithium introduced into the silicon through prelithiation is therefore generally not reversible, or at least not entirely reversible, when the battery is cycled between the end voltages U3 and U2 or U4.

Cycling refers generally to a full cycle of charging and discharging of the lithium-ion battery. Within a full cycle, the battery generally obtains the state of its maximum charge during charging and the state of its maximum discharge during discharging. In a charging/discharging cycle of the battery, the maximum storage capacity of the battery for electrical current is utilized once, as is known. The maximum charging and discharging of the battery may be adjusted, for example, by way of its upper or lower cut-off voltage. During cycling, the battery is utilized as usual as a storage medium for electrical current.

Formation, in the generally familiar way, represents measures by which the lithium-ion battery is converted to its ready-to-use form as a storage medium for electrical current. Formation may comprise, for example, single or multiple charging and discharging of the battery with the effect of chemical modification of battery constituents, especially a prelithiation of the active anode material or the formation of an initial solid electrolyte interface (SEI) on the active anode material, or else an aging storage and possibly elevated temperature, thereby converting the battery to its ready-to-use state as a storage medium for electrical current. Generally speaking, therefore, a lithium-ion battery which has undergone formation is structurally different from its unformationed counterpart. Chronologically, formation takes place, as usual, before cycling. Formation does not include any cycling, as is known.

Formation and cycling are also generally different in that during formation there is a greater loss of mobile silicon or greater losses of capacity of the lithium-ion battery than during cycling. The formation of the lithium-ion battery is accompanied by capacity losses of, for example, >1% or >5%. In two successive cycling steps, more particularly in two successive cycling steps within the first ten cycling steps after formation, there are capacity losses of preferably <1%, more preferably <0.5%, and more preferably still <0.1%.

The volumetric capacity of the anode coatings may be determined by dividing the delithiation capacity β per unit area, described in the examples, by the thickness of the anode coating. The thickness of the anode coating can be determined using the Mitutoyo digital dial gauge (1 μm to 12.7 mm) with precision measuring table.

Lithiation capacity refers generally to the maximum amount of lithium which can be accommodated by the active anode material. For silicon this amount may be expressed generally through the formula Li₄₄Si. The maximum specific capacity of silicon for lithium, in other words the maximum lithiation capacity of silicon, corresponds generally to 4200 mAh per gram of silicon.

The total degree of lithiation α generally denotes the fraction of the lithiation capacity of silicon that is occupied maximally on cycling of the lithium-ion battery. The total degree of lithiation α therefore generally comprises the fraction of the lithiation capacity of silicon that is occupied through prelithiation of silicon (degree of prelithiation α1) and also the fraction of the lithiation capacity of silicon that is occupied through the partial lithiation of the anode material during charging, more particularly during complete charging, of the lithium-ion battery (degree of lithiation α2). The total degree of lithiation α is given, generally, by the sum total of the degree of prelithiation α1 and the degree of lithiation α2. The total degree of lithiation α is based preferably on the fully charged lithium-ion battery.

The total degree of lithiation α of silicon is 10% to 75%, preferably 20% to 65%, more preferably 25% to 55%, and most preferably 30% to 50% of the maximum lithiation capacity of silicon.

In the partially lithiated anode material of the fully charged lithium-ion battery, the ratio of the lithium atoms to the silicon atoms corresponds preferably to the formula Li_{0.45}Si to Li_{3.30}Si, more preferably Li_{0.09}Si to Li2.90Si, very preferably Li_{1.10}Si to Li_{2.40}Si, and most preferably Li_{1.30}Si to Li_{2.20}Si. These figures may be determined on the basis of degree of lithiation α and the formula Li₄₄Si.

In the partially lithiated anode material of the fully charged lithium-ion battery, the capacity of silicon is utilized at preferably 400 to 3200 mAh per gram of silicon, more preferably 850 to 2700 mAh per gram of silicon, very preferably 1000 to 2300 mAh per gram of silicon, and most preferably 1250 to 2100 mAh per gram of silicon. These figures are given by the degree of lithiation α and the maximum lithiation capacity of silicon (4200 mAh per gram of silicon).

Of the lithiation capacity of silicon that is utilized maximally in the lithium-ion battery in the invention, more particularly of the total degree of lithiation α, preferably 50% to 90%, more preferably 60% to 85%, and most preferably 70% to 80% is utilized reversibly for the cycling or for the charging and/or discharging of the lithium-ion battery.

The degree of prelithiation α1 of silicon is preferably 5% to 50%, more preferably 7% to 46%, very preferably 8% to 30% or 10% to 44%, and most preferably 10% to 20% or alternatively 20% to 40% of the lithiation capacity of silicon. The degree of prelithiation α1 denotes generally the fraction of the lithiation capacity of silicon that is occupied through prelithiation. A methodology for determining the degree of prelithiation α1 is described later on below in the examples.

The amount of lithium introduced into the silicon through prelithiation corresponds preferably to the formula Li_{0.20}Si to Li_{2.20}Si, more preferably Li_{0.25}Si to Li_{1.80}Si, very preferably Li_{0.35}Si to Li_{1.30}Si, and most preferably Li_{0.45}Si to Li_{0.90}Si. These figures may be determined using the degree of prelithiation α1 and the formula Li₄₄Si.

The amount of lithium introduced into the silicon through prelithiation corresponds to a lithiation capacity of preferably 200 to 2100 mAh per gram of silicon, more preferably 250 to 1700 mAh per gram of silicon, very preferably 340 to 1300 mAh per gram of silicon, and most preferably 400 to 850 mAh per gram of silicon. These figures are given by the degree of prelithiation α1 and by the maximum lithiation capacity of silicon (4200 mAh per gram of silicon).

During electrochemical prelithiation the anode is charged with preferably 800 to 1500 mAh/g, more preferably 900 to 1200 mAh/g, and after complete discharging preferably with ≤1500 mAh/g, more preferably 150 to 1000 mAh/g, based in each case on the mass of the anode coating.

The formation preferably comprises no predoping. Prelithiation generally comprises no predoping. In the predoping of silicon, more particularly of silicon containing silicon oxide or silicon suboxide, lithium silicates are typically formed. During prelithiation, in contrast, lithium silicides are generally formed.

The lithium-ion batteries are generally constructed or configured and/or generally operated in such a way that the material of the anode (anode material), more particularly the silicon, is only partially lithiated in the fully charged battery. “Fully charged” denotes the battery condition in which the anode material of the battery, more particularly silicon, exhibits its highest lithiation. A partial lithiation of the anode material means that the lithiation capacity or the maximum lithium uptake capacity of the active anode material, more particularly of silicon, is not exhausted.

In the course of the cycling or charging and/or discharging of the lithium-ion battery, in accordance with the partial lithiation according to the invention, the ratio of the lithium atoms to the silicon atoms in the anode material (Li/Si ratio) changes by preferably ≤2.2, more preferably ≤1.3, and most preferably ≤0.9. The aforesaid Li/Si ratio changes preferably by ≥0.2, more preferably ≥0.4 and most preferably ≥0.6.

The degree of lithiation α2 refers generally to the fraction of the lithiation capacity of silicon that is maximally utilized for the cycling of the lithium-ion battery. Expressed alternatively, the degree of lithiation α2 is a measure of the extent to which the lithiation capacity of silicon is maximally utilized for the cycling of the battery. The degree of lithiation α2 of silicon is preferably 5% to 50%, more preferably 10% to 45%, and most preferably 25% to 40% of the lithiation capacity of silicon. A methodology for determining the degree of lithiation α2 is described later on below in the examples.

In the course of the cycling of the lithium-ion battery, the capacity of the silicon anode material is utilized preferably at ≤50%, more preferably at ≤45%, and most preferably at ≤40%, based on a capacity of 4200 mAh per gram of silicon.

The ratio of the lithium atoms to the silicon atoms in the anode of a lithium-ion battery (Li/Si ratio) may be adjusted, for example, by way of the electrical charge flow during charging and discharging of the lithium-ion battery. The degree of lithiation α2 of the active anode material, more particularly of silicon, generally changes in proportion to the electrical charge flow. With this variant, generally, during charging of the lithium-ion battery, the lithiation capacity of the active anode material is not fully exhausted and, during discharging of the lithium-ion battery, not all of the lithium is extracted from the active anode material. This may be established, for example, by corresponding cut-off voltages or, alternatively expressed, by limitation of the charge flow during charging or discharging of the lithium-ion battery. In this way it is also possible to establish the total degree of lithiation α and hence the degree of prelithiation α1 as well.

In the case of an alternative, preferred variant, the Li/Si ratio of a lithium-ion battery is adjusted through the anode to cathode ratio (cell balancing). In this case the lithium-ion batteries are designed such that the lithium uptake capacity of the anode is preferably greater than the lithium release capacity of the cathode. As a result of this, the lithium uptake capacity of the anode in the fully charged battery is not fully exhausted. In this way as well, it is possible to adjust the degree of lithiation α2, the total degree of lithiation α, and hence also the degree of prelithiation α1.

The silicon-containing anode preferably comprises silicon-containing particles, very preferably 5 silicon particles, as active anode material.

The volume-weighted particle size distribution of the silicon particles is situated preferably between the diameter percentiles d₁₀≥0.2 μm and d₉₀≤20.0 μm, more preferably between d₁₀≥0.2 μm and d₉₀≤10.0 μm, and most preferably between d₁₀>0.2 μm to d₉₀≤3.0 μm.

The silicon particles have a volume-weighted particle size distribution with diameter percentiles d₁₀ of preferably ≤10 μm, more preferably ≤5 μm, more preferably still ≤3 μm, and most preferably ≤1 μm. The silicon particles have a volume-weighted particle size distribution with diameter percentiles d90 of preferably ≥0.5 μm. In one embodiment of the present invention the aforesaid d90 is preferably ≥5 μm.

The volume-weighted particle size distribution of the silicon particles has diameter percentiles d₅₀ of preferably 0.5 to 10.0 μm, more preferably 0.6 to 7.0 μm, more preferably still 2.0 to 6.0 μm, and most preferably 0.7 to 3.0 μm. Also preferred, alternatively, are silicon particles whose volume-weighted particle size distribution has diameter percentiles d₅₀ of 10 to 500 nm, more preferably 20 to 300 nm, more preferably still 30 to 200 nm, and most preferably 40 to 100 nm.

The volume-weighted particle size distribution of the silicon particles may be determined by static laser scattering using the Mie model with the Horiba LA 950 instrument, with ethanol as dispersing medium for the silicon particles.

The silicon particles are preferably not aggregated, preferably not agglomerated and/or preferably not nanostructured. “Aggregated” means that a number of spherical or very largely spherical primary particles, as are initially formed, for example, during the production of silicon particles by means of gas-phase operations, grow together, fuse together or sinter together to form aggregates. Aggregates are therefore particles which comprise a plurality of primary particles. Aggregates may form agglomerates. Agglomerates are a loose coalition of aggregates. Agglomerates can typically be easily broken up again into aggregates using kneading or dispersing methods. Aggregates cannot be broken down entirely into the primary particles using such methods. As a result of the way in which they are formed, aggregates and agglomerates inevitably have quite different sphericities and grain morphologies from the silicon particles of the invention. The presence of silicon particles in the form of aggregates or agglomerates may be made visible by means, for example, of conventional scanning electron microscopy (SEM). Conversely, static light scattering methods for determining the particle size distributions or particle diameters of silicon particles are unable to distinguish between aggregates or agglomerates.

Non-nanostructured silicon particles generally have characteristic BET surface areas. The BET surface areas of the silicon particles are preferably 0.01 to 30.0 m²/g, more preferably 0.1 to 25.0 m²/g, very preferably 0.2 to 20.0 m²/g, and most preferably 0.2 to 18.0 m²/g. The BET surface area is determined in accordance with DIN 66131 (using nitrogen).

The silicon particles have a sphericity of preferably 0.3≤ψ≤0.9, more preferably 0.5≤ψ≤0.85 and most preferably 0.65≤ψ≤0.85. Silicon particles having such sphericities are accessible in particular through production by means of milling operations. The sphericity ψ is the ratio of the surface area of a sphere of equal volume to the actual surface area of a body (definition by Wadell). Sphericities may be ascertained, for example, from conventional SEM images.

Polycrystalline silicon particles are preferred. The silicon particles are based preferably on elemental silicon. The elemental silicon may be high-purity silicon or silicon from metallurgical processing, which may, for example, have elemental contamination, such as Fe, Al, Ca, Cu, Zr, C. The silicon particles may optionally be doped with foreign atoms (such as B, P, As, for example). Such foreign atoms are generally present only to a small extent.

The silicon particles may comprise silicon oxide, especially on the surface of the silicon particles. If the silicon particles do comprise a silicon oxide, the stoichiometry of the oxide SiOₓ is preferably in the range 0<x<1.3. The layer thickness of silicon oxide on the surface of the silicon particles is preferably less than 10 nm.

The surface of the silicon particles may optionally be covered by an oxide layer or by other inorganic and organic groups. Particularly preferred silicon particles carry Si—OH— or Si—H— groups or covalently attached organic groups, such as alcohols or alkenes, for example, on the surface.

The silicon particles have a silicon content of ≥90 wt %, preferably ≥95 wt %, more preferably 97 wt %, and most preferably 99 wt %, based on the total weight of the silicon particles.

The silicon particles may be produced, for example, by milling operations. Milling operations contemplated include, for example, wet milling operations or preferably dry milling operations, as described for example in DE-A 102015215415.

The silicon particles may optionally also be coated with carbon (C-coated Si particles) or be present in the form of silicon/carbon composite particles (Si/C-composite particles). The C-coated Si particles contain preferably 1 to 10 wt % of carbon and preferably 90 to 99 wt % of silicon particles, based in each case on the total weight of C-coated Si particles. In Si/C composite particles, the silicon particles are preferably incorporated into a porous carbon matrix. Alternatively, pores of the porous carbon matrix may be coated with silicon, in the form for example of a silicon film or in the form of silicon particles. The silicon-containing porous carbon matrix is preferably coated with nonporous carbon. The carbon coating of the C-coated Si particles or of the Si/C composite particles has a mean layer thickness in the range from preferably 1 to 50 nm (method of determination: scanning electron microscopy (SEM)). The C-coated Si particles or the Si/C composite particles have average particle diameters d₅₀ of preferably 1 to 15 μm. The BET surface area of the aforesaid particles is preferably 0.5 to 5 m²/g (determined according to DIN ISO 9277: 2003-05 using nitrogen). Further information regarding the C-coated Si particles or the Si/C composite particles and also processes for producing them are found in WO 2018/082880, WO 2017/140642 or WO 2018/145732.

The anode material preferably comprises silicon particles, one or more binders, optionally graphite, optionally one or more further electrically conducting components, and optionally one or more adjuvants.

The silicon fraction in the anode material is preferably 40 to 95 wt %, more preferably 50 to 90 wt %, and most preferably 60 to 80 wt %, based on the total weight of the anode material.

Preferred binders are polyacrylic acid or its alkali metal salts, more particularly lithium or sodium salts, polyvinyl alcohols, cellulose or cellulose derivates, polyvinylidene fluoride, polytetrafluoroethylene, polyolefins, polyimides, more particularly polyamideimides, or thermoplastic elastomers, more particularly ethylene-propylene-diene terpolymers. Particularly preferred are polyacrylic acid, polymethacrylic acid, or cellulose derivates, more particularly carboxymethylcellulose. Also particularly preferred are the alkali metal salts, more particularly lithium or sodium salts, of the aforesaid binders. The binders have a molar mass of preferably 100 000 to 1 000 000 g/mol.

The graphite used may generally be natural or synthetic graphite. The graphite particles preferably have a volume-weighted particle size distribution between the diameter percentiles d₁₀>0.2 μm and d₉₀<200 μm.

Preferred further electrically conducting components are conductive carbon black, carbon nanotubes or metallic particles, copper for example. Amorphous carbon, more particularly hard carbon or soft carbon, is also preferred. Amorphous carbon, as is known, is not graphitic. The anode material contains preferably 0 to 40 wt %, more preferably 0 to 30 wt %, and most preferably 0 to 20 wt % of further electrically conductive components, based on the total weight of the anode material.

Examples of anode material adjuvants are pore formers, dispersants, leveling agents, or dopants, such as elemental lithium.

Preferred formulations for the anode material of the lithium-ion batteries contain preferably 5 to 95 wt %, more particularly 60 to 85 wt %, of silicon particles; 0 to 40 wt %, more particularly 0 to 20 wt %, of further electrically conductive components; 0 to 80 wt %, more particularly 5 to 30 wt %, of graphite; 0 to 25 wt %, more particularly 1 to 15 wt %, of binders; and optionally 0 to 80 wt %, more particularly 0.1 to 5 wt %, of adjuvants; the figures in wt % are based on the total weight of the anode material, and the fractions of all the constituents of the anode material add up to 100 wt %.

In a preferred formulation for the anode material, the fraction of graphite particles and of further electrically conductive components is in total at least 10 wt %, based on the total weight of the anode material.

The constituents of the anode material may be processed to an anode ink or anode paste in, for example, a solvent, such as water, hexane, toluene, tetrahydrofuran, N-methylpyrrolidone, M-ethylpyrrolidone, acetone, ethyl acetate, dimethylsulfoxide, dimethylacetamide or ethanol, or in solvent mixtures, preferably using rotor-stator machines, high-energy mills, planetary kneaders, stirred ball mills, shaking tables or ultrasonic devices. p The anode ink or anode paste has a pH of preferably 2 to 7.5, more preferably ≤7.0 (determined at 20° C., using, for example, the WTW pH 340i pH meter with SenTix RJD probe).

The anode ink or anode paste may be applied, for example, to a copper foil or to another current collector, as described for example in WO 2015/117838.

The layer thickness, referring to the dry film thickness of the anode coating, is preferably 2 μm to 500 μm, more preferably from 10 μm to 300 μm.

The anodes of the lithium-ion batteries generally comprise anode coatings and current collectors. Anode coatings are based generally on anode materials. The procedure of the invention advantageously also enables anode coatings having high volumetric capacities. The anode coatings preferably have a volumetric capacity of ≥660 mAh/cm³. The volumetric capacity of the anode coatings may be determined by dividing the delithiation capacity per unit area, β, described below by the thickness of the anode coating. The thickness of the anode coating can be determined using the Mitutoyo digital dial gauge (1 μm to 12.7 mm) with precision measuring table.

The cathode materials in the cathode preferably comprise lithium cobalt oxide, lithium nickel oxide, lithium nickel cobalt oxide (doped or undoped), lithium manganese oxide (spinel), lithium nickel cobalt manganese oxides, lithium nickel manganese oxides (LiCoO₂, Li(NiₓMn_{y}Co_{1-x-y})O₂ (x is greater than or equal to 0 and less than or equal to 1, y is greater than or equal to 0 and less than or equal to 1), Li(NiₓCo_{y}Al_{1-x-y})O₂ (x is greater than or equal to 0 and less than or equal to 1, y is greater than or equal to 0 and less than or equal to 1), Li₂MnO₄, LiNi0.5Mn_{0.5}O₂, LiNi_{0.5}Mn_{1.5}O₄, and a Li₂MnO₃ (1-a) Li(NiₓMn_{y}Co_{1-x-y})O₂ (x is greater than or equal to 0 and less than equal to 1 and y is greater than or equal to 0 and less than or equal to 1)) or lithium vanadium oxides.

The separator is generally an electrically insulating membrane which is permeable to ions, as is customary in battery production. The separator, as is known, separates the anode from the cathode and so prevents electronically conducting connections between the electrodes (short circuit).

The electrolyte is typically a solution of a lithium salt (i.e., conductive salt) in an aprotic solvent. Examples of conductive salts are lithium hexafluorophosphate, lithium hexafluoroarsenate, lithium perchlorate, lithium tetrafluoroborate, LiCF₃SO₃, LiN(CF₃SO₂) or lithium borates. The concentration of the conductive salt, based on the solvent, is preferably between 0.5 mol/l and the solubility limit of the respective salt. With particular preference it is 0.8 mol/l to 1.2 mol/l.

Solvents used may be cyclic carbonates, propylene carbonate, ethylene carbonate, fluoroethylene carbonate, dimethyl carbonate, diethyl carbonate, ethylmethyl carbonate, dimethoxyethane, diethoxyethane, tetrahydrofuran, 2-methyltetrahydrofuran, gamma-butyrolactone, dioxolane, acetonitrile, organic carbonic esters or nitriles, individually or as mixtures thereof.

The electrolyte preferably comprises a film former, such as vinylene carbonate or fluoroethylene carbonate. The fraction of the film former in the electrolyte is preferably between 0.1 wt % and 20.0 wt %, more preferably between 0.5 wt % and 10 wt %.

The electrolyte is preferably admixed with individual or multiple fluorinated additives, such as fluorinated acetates, fluorinated carbamates, fluorinated nitriles, fluorinated sulfones and/or fluorinated carbamates, such as methyl(2,2,2-trifluoroethyl) carbonate (FEMC), fluoroethylene carbonate (FEC), difluoroethylene carbonate (F2EC), trifluoroethylene carbonate (F3EC), ethyl (1-fluoroethyl) carbonate (FDEC), di(1-fluoroethyl) carbonate F2DEC, 1-fluoroethyl(2,2,2-trifluoroethyl) carbonate (F4DEC). The additive content is between 0 wt % and 50 wt %. Fluorinated additives increase the high-voltage stability of the electrolyte.

All of the substances and materials utilized for producing the lithium-ion battery of the invention, as described above, are known. The production of the parts of the battery of the invention and the assembly thereof to form the battery of the invention take place in accordance with the methods known from the field of battery production.

### EXAMPLES

The methods of the invention and the compositions are described below in examples. All percentage figures are based on the weight. Unless otherwise indicated, all manipulations are performed at room temperature of 23° C. and under atmospheric pressure (1.013 bar). Unless indicated otherwise, all data relating to the description of product properties are valid at room temperature of 23° C. and under atmospheric pressure (1.013 bar).

The apparatus comprises standard commercial laboratory instruments of the kind available commercially from numerous apparatus manufacturers.

Experimental determination of the total degree of lithiation α:

The degree of lithiation α of the active material may be determined using the following formula I:

$$α = \frac{β}{γ \cdot FG \cdot {ω}_{AM}} , \qquad ( I )$$

where
β: delithiation capacity per unit area of the active material-containing anode at the respective end-of-charging voltage of the lithium-ion battery which has been delithiated in a half-cell measurement against lithium;
γ: maximum capacity of the active material for lithium (corresponds to 4200 mAh/g for silicon with a stoichiometry of Li_{4,4}Si);
FG: surface weight of the anode coating in g/cm²;
ω_{AM}: percentage weight fraction of active material in the anode coating.

Experimental determination of the delithiation capacity per unit area, β:

The lithium-ion battery is converted into the electrically charged state by charging it by the cc (constant current) method with a constant current of 5 mA/g (corresponding to C/25) until the respective end-of-charge voltage is reached, more particularly the voltage limit of 4.2 V. The anode here is lithiated. The lithium-ion battery thus charged is opened and the anode is taken out and used to construct a button half-cell (type CR2032, Hohsen Corp.) with a lithium counterelectrode (Rockwood lithium, thickness 0.5 mm, diameter=15 mm). A glass fiber filter paper (Whatman, GD type D) impregnated with 120 μl of electrolyte may serve as a separator (diameter=16 mm). The electrolyte used is a 1.0 molar solution of lithium hexafluorophosphate in a 1:4 (v/v) mixture of fluoroethylene carbonate and diethyl carbonate. The cell is generally constructed in a glovebox (<1 ppm of H₂O and O₂). The water content of the dry mass of all the ingredients is preferably below 20 ppm. The delithiation capacity per unit area, β, of the active material-containing anode coating is determined by charging the button half-cell thus produced (working electrolyte=positive electrode=active material anode; counterelectrode=anode=lithium) at C/25 until the voltage limit of 1.5 V has been reached. The Si anode here is delithiated. The electrochemical measurements on full cell and half-cell are carried out at 20° C. The constant current stated above is based on the weight of the coating of the positive electrode.

Experimental determination of the degree of prelithiation, α1:

The lithium-ion battery is converted into the electrically uncharged state by discharging it by the cc (constant current) method with a constant current of 5 mA/g (corresponding to C/25) until the respective end-of-discharge voltage is reached, more particularly the voltage limit of 3.2 V. The anode here is delithiated. The lithium-ion battery thus discharged is opened and the anode is taken out and used to construct a button half-cell (type CR2032, Hohsen Corp.) with a lithium counterelectrode (Rockwood lithium, thickness 0.5 mm, diameter=15 mm). A glass fiber filter paper (Whatman, GD type D) impregnated with 120 μl of electrolyte may serve as a separator (diameter=16 mm). The electrolyte used is a 1.0 molar solution of lithium hexafluorophosphate in a 1:4 (v/v) mixture of fluoroethylene carbonate and diethyl carbonate. The cell is generally constructed in a glovebox (<1 ppm of H₂O and O₂). The water content of the dry mass of all the ingredients is preferably below 20 ppm. The degree of prelithiation, α1, brought about by the prelithiation is determined by charging the button half-cell thus produced (working electrode=positive electrode=active material anode;

counterelectrode=anode=lithium) at C/25 until the voltage limit of 1.5 V has been reached. The Si anode here is delithiated further. The electrochemical measurements on full-cell and half-cell are carried out at 20° C. The constant current stated above is based on the weight of the coating of the positive electrode.

The degree of prelithiation, al, is then computed using the following formula II:

$${α}_{1} = \frac{δ}{γ \cdot FG \cdot {ω}_{AM}} , \qquad ( II )$$

where
δ: delithiation capacity per unit area of the active material-containing anode at the respective end-of-discharge voltage of the lithium-ion battery which has been further delithiated in a half-cell measurement against lithium;
γ: maximum capacity of the active material for lithium (corresponds to 4200 mAh/g for silicon with a stoichiometry of Li_{4,4}Si);
FG: surface weight of the anode coating in g/cm²;
ω_{AM}: percentage weight fraction of active material in the anode coating.

Determination of the degree of lithiation, α2:

The degree of lithiation, α2, is obtained algorithmically from the difference between the total degree of lithiation α and the degree of preliathiation α1, as illustrated also by the following formula:

Degree of lithiation α2=(total degree of lithiation α)−(degree of prelithiation α1).

### Example 1

Production of unaggregated, splitter-shaped silicon particles by milling:

The silicon powder was produced according to WO2018/041339 by milling of coarse crushed Si from the production of solar silicon in a fluidized-bed jet mill (Netzsch-Condux CGS16 with 90 m³/h of nitrogen with 7 bar as milling gas).

The resulting product consisted of individual, unaggregated, splitter-shaped particles (SEM) and had a particle distribution d10=2.23 μm, d50=4.48 μm and d90=7.78 μm and also a span (d90-d10) of 5.5 μm (determined by means of static laser scattering, Horiba LA 950 instrument, using the Mie model, in a highly diluted suspension in ethanol).

### Example 2

Anode comprising the silicon particles from example 1:

29.709 g of polyacrylic acid (Sigma-Aldrich, Mw 450 000 g/mol) dried to constant weight at 85° C. and 751.60 g of deionized water were agitated by means of a shaker (290 l/min) for 2.5 h until complete dissolution of the polyacrylic acid. Lithium hydroxide monohydrate (Sigma-Aldrich) was added in portions to the solution until the pH was 7.0 (measured using WTW pH 340i pH meter with SenTix RJD probe). The solution was then mixed for a further 4 h using the shaker.

7.00 g of the silicon particles from example 1 were then dispersed in 12.50 g of the neutralized polyacrylic acid solution (concentration 4 wt %) and 5.10 g of deionized water using a dissolver at a circumferential velocity of 4.5 m/s for 5 min and of 12 m/s for 30 min, with cooling at 20° C. Following addition of 2.50 g of graphite (Imerys, KS6L C), stirring was then continued for 30 min at a circumferential velocity of 12 m/s. After having been degassed, the dispersion was applied to a copper foil having a thickness of 0.030 mm (Schlenk Metallfolien, SE-Cu58) by means of a film-drawing frame having a gap height of 0.10 mm (Erichsen, model 360). The anode coating produced in this way was subsequently dried at 80° C. and 1 bar atmospheric pressure for 60 min.

The anode coating thus dried had a mean surface weight of 2.85 mg/cm² and a layer thickness of 32 μm.

### Example 3

Lithium-ion battery with electrode coating from example 2:

The electrode coating from example 2 was used as the counterelectrode or negative electrode (Dm=15 mm), and a coating based on 6:2:2 lithium nickel manganese cobalt oxide having a content of 94.0 wt % and a mean surface weight of 15.9 mg/cm² (procured from SEI Corp.) was used as the working electrode or positive electrode (Dm=15 mm). A glass fiber filter paper (Whatman, GD type A/E) impregnated with 60 μl of electrolyte served as a separator (Dm=16 mm). The electrolyte used consisted of a 1.0 molar solution of lithium hexafluorophosphate in a 1:4 (v/v) mixture of fluoroethylene carbonate and diethyl carbonate. The cell (button cell, 2-electrode arrangement, type CR2032, Hohsen Corp.) was constructed in a glovebox (<1 ppm of H₂O, O₂), and the water content in the dry mass of all the components used was below 20 ppm.

### Examples 4-9

Electrochemical testing with and without prelithiation of the lithium-ion battery from example 3:

The electrochemical tests were carried out on the lithium-ion battery from example 3. Electrochemical testing was carried out at 20° C. The cell was charged by the cc/cv (constant current/constant voltage) method at a constant current of 12.5 mA/g (corresponding to C/10) to the point of attainment of the voltage limit valid in each case in the first cycle (formation), and until attainment of 60 mA/g (corresponding to C/2) in the subsequent cycles (cycling), and following attainment of the voltage limit valid in each case, it was charged at constant voltage until the current dropped below a level of 1.2 mA/g (corresponding to C/100) or 15 mA/g (corresponding to C/8). The cell was discharged by the cc (constant current) method at a constant current of 12.5 mA/g (corresponding to C/10) to the point of attainment of the respectively valid voltage limit in the first cycle, and of 60 mA/g (corresponding to C/2) in the subsequent cycles until the respectively valid voltage limit was attained. The specific current selected was based on the weight of the coating of the positive electrode.

In light of the formulation, the lithium-ion battery was operated by cell balancing with partial lithiation of the anode.

The test conditions for examples 4 and 9 and for the non-inventive, comparative examples, examples 5 to 8, can be found in table 1.

TABLE 1
Test conditions of examples 4 and 9 and
of comparative examples 5 to 8.

| | Charging | Discharging | Charging | Discharging |
|---|---|---|---|---|
| | Cycle 1 | Cycle 1 | Cycle 2 | Cycle 2 |
| (Comp.) | Voltage limit | Voltage limit | Voltage limit | Voltage limit |
| Ex. | [V] | [V] | [V] | [V] |
| 4 | 4.50 | 3.20 | 4.20 | 3.05 |
| 5* | 4.20 | 3.00 | 4.20 | 3.00 |
| 6* | 4.50 | 3.00 | 4.50 | 3.00 |
| 7* | 4.50 | 3.20 | 4.50 | 3.05 |
| 8* | 4.30 | 3.05 | 4.20 | 3.00 |
| 9 | 4.40 | 3.14 | 4.20 | 3.03 |

*not inventive

Table 2 contains the results of testing of the examples. The lithium-ion batteries from inventive examples 4 and 9, surprisingly, exhibited a more stable electrochemical behavior (>20 cycles) in comparison to the lithium-ion batteries from the non-inventive, comparative examples 5 to 8, while at the same time having a high discharge capacity after cycle 2.

TABLE 2
Results of testing of examples 4 and 9 and of the non-inventive,
comparative examples 5 to 8:

| | Charging | Discharging | Charging | Discharging | |
|---|---|---|---|---|---|
| | Capacity | Capacity | Capacity | Capacity | Number of |
| | Cycle 1 | Cycle 1 | Cycle 2 | Cycle 2 | cycles with ≥ |
| | (Q_{L,Z1}) | (Q_{EL,Z1}) | (Q_{L,Z2}) | (Q_{L,Z2}) | 80% capacity |
| Example | [mAh/cm²] | [mAh/cm²] | [mAh/cm²] | [mAh/cm²] | retention |
| 4 | 3.53 | 2.44 | 2.01 | 2.23 | 285 |
| 5* | 2.91 | 2.38 | 2.38 | 2.21 | 247 |
| 6* | 3.47 | 2.84 | 2.82 | 2.66 | 125 |
| 7* | 3.41 | 2.37 | 2.38 | 2.60 | 124 |
| 8* | 3.06 | 2.41 | 2.27 | 2.19 | 251 |
| 9 | 3.33 | 2.44 | 2.16 | 2.25 | 274 |

*not inventive

TABLE 3
lists the degrees of lithiation α, α1 and α2 of the examples:

| | Degree of lithiation | | |
|---|---|---|---|
| Example | α | α1 | α2 |
| 4 | 0.34 | 0.07 | 0.27 |
| 5* | 0.27 | 0.00 | 0.27 |
| 6* | 0.38 | 0.06 | 0.32 |
| 7* | 0.32 | 0.06 | 0.26 |
| 8* | 0.29 | 0.02 | 0.27 |
| 9 | 0.32 | 0.05 | 0.27 |

*not inventive

1-12. (canceled)

13. A method for pre-lithiating a silicon-containing anode in a lithium-ion battery, comprising:
providing a lithium-ion battery, wherein the lithium-ion battery comprises a cathode of lithium transition metal oxide, an anode, a separator, and an organic electrolyte;
wherein the end voltage during a battery charging cycle procedure U1 is between 4.35 V and 4.80 V;
wherein during subsequent battery charging cycles, the end voltage during discharging of the battery U2 does not drop below 3.01 V;
wherein during subsequent battery charging cycles, the end voltage during charging of the lithium-ion battery U3 is lower than the end voltage during charging of the lithium-ion battery U1;
wherein the lithium-ion battery is charged by the cc/cv (constant current/constant voltage) method; and
wherein the end voltage during subsequent discharging of the lithium-ion battery U4 is lower than the end voltage during discharging of the lithium-ion battery U2 and does not drop below 3.01 V.

14. The method of claim 13, wherein U1 is between 4.37 V and 4.70 V.

15. The method of claim 13, wherein U2 for C-rates <C/5 is between 3.30 V and 3.10 V and for C-rates >C/5 is between 3.02 V and 3.20 V.

16. The method of claim 13, wherein the method is part of the lithium-ion battery formation procedure.

17. The method of claim 13, wherein the ratio of the lithium atoms to the silicon atoms in the partially lithiated anode material of the fully charged lithium-ion battery corresponds to the formula Li_{0.45}Si to Li_{3.30}Si.

18. The method of claim 13, wherein the capacity of silicon is utilized at 400 to 3200 mAh per gram of silicon in the partially lithiated anode material of the fully charged lithium-ion battery;
wherein the capacity of silicon is given by the degree of lithiation α and by the maximum lithiation capacity of silicon (4200 mAh per gram of silicon) and the degree of lithiation α of the active material is computed using the following formula I:
$$α = \frac{β}{γ \cdot FG \cdot {ω}_{AM}} ; \qquad ( I )$$
wherein β if a delithiation capacity per unit area of the active material-containing anode at the respective end-of-charging voltage of the lithium-ion battery which has been delithiated in a half-cell measurement against lithium;
wherein γ is a maximum capacity of the active material for lithium (corresponds to 4200 mAh/g for silicon with a stoichiometry of Li_{4,4}Si);
wherein FG is a surface weight of the anode coating in g/cm²; and
wherein ω_{AM} is a percentage weight fraction of active material in the anode coating.

19. The method of claim 13, wherein the amount of lithium introduced into the silicon through pre-lithiation corresponds to the formula Li_{0.20}Si to Li_{2.20}Si.

20. The method of claim 13, wherein the amount of lithium introduced into the silicon through pre-lithiation corresponds to a lithiation capacity of 200 to 2100 mAh per gram of silicon;
wherein the lithiation capacity is given by the degree of prelithiation α1 and by the maximum lithiation capacity of silicon (4200 mAh per gram of silicon) and the degree of pre-lithiation α1 is computed using the following formula II:
$${α}_{1} = \frac{δ}{γ \cdot FG \cdot {ω}_{AM}} ; \qquad ( II )$$
wherein δ is a delithiation capacity per unit area of the active material-containing anode at the respective end-of-discharge voltage of the lithium-ion battery which has been further delithiated in a half-cell measurement against lithium;
wherein γ is a maximum capacity of the active material for lithium (corresponds to 4200 mAh/g for silicon with a stoichiometry of Li_{4,4}Si);
wherein FG is a surface weight of the anode coating in g/cm²; and
wherein ω_{AM} is a percentage weight fraction of active material in the anode coating.

21. The method of claim 13, wherein the silicon-containing anode comprises silicon particles as active anode material.

22. The method of claim 21, wherein the volume-weighted particle size distribution of the silicon particles is between the diameter percentiles d₁₀≥0.2 μm and d₉₀≤20.0 μm.

23. A lithium-ion battery, comprising:
wherein the lithium-ion battery comprises a cathode of lithium transition metal oxide, an anode, a separator, and an organic electrolyte;
wherein the end voltage during a battery charging cycle procedure U1 is between 4.35 V and 4.80 V;
wherein during subsequent battery charging cycles, the end voltage during discharging of the battery U2 does not drop below 3.01 V;
wherein during subsequent battery charging cycles, the end voltage during charging of the lithium-ion battery U3 is lower than the end voltage during charging of the lithium-ion battery U1;
wherein the lithium-ion battery is charged by the cc/cv (constant current/constant voltage) method; and
wherein the end voltage during subsequent discharging of the lithium-ion battery U4 is lower than the end voltage during discharging of the lithium-ion battery U2 and does not drop below 3.01 V.

24. The lithium-ion battery of claim 23, wherein U1 is between 4.37 V and 4.70 V.

25. The lithium-ion battery of claim 23, wherein U2 for C-rates<C/5 is between 3.30 V and 3.10 V and for C-rates>C/5 is between 3.02 V and 3.20 V.

26. The lithium-ion battery of claim 23, wherein the ratio of the lithium atoms to the silicon atoms in the partially lithiated anode material of the fully charged lithium-ion battery corresponds to the formula L_{1.45}Si to Li_{3.30}Si.

27. The lithium-ion battery of claim 23, wherein the capacity of silicon is utilized at 400 to 3200 mAh per gram of silicon in the partially lithiated anode material of the fully charged lithium-ion battery;
wherein the capacity of silicon is given by the degree of lithiation α and by the maximum lithiation capacity of silicon (4200 mAh per gram of silicon) and the degree of lithiation α of the active material is computed using the following formula I:
$$α = \frac{β}{γ \cdot FG \cdot {ω}_{AM}} ; \qquad ( I )$$
wherein β if a delithiation capacity per unit area of the active material-containing anode at the respective end-of-charging voltage of the lithium-ion battery which has been delithiated in a half-cell measurement against lithium;
wherein γ is a maximum capacity of the active material for lithium (corresponds to 4200 mAh/g for silicon with a stoichiometry of Li_{4,4}Si);
wherein FG is a surface weight of the anode coating in g/cm²; and
wherein ω_{AM} is a percentage weight fraction of active material in the anode coating.

28. The lithium-ion battery of claim 23, wherein the amount of lithium introduced into the silicon through pre-lithiation corresponds to the formula Li_{0.20}Si to Li_{2.20}Si.

29. The lithium-ion battery of claim 23, wherein the amount of lithium introduced into the silicon through pre-lithiation corresponds to a lithiation capacity of 200 to 2100 mAh per gram of silicon;
wherein the lithiation capacity is given by the degree of prelithiation α1 and by the maximum lithiation capacity of silicon (4200 mAh per gram of silicon) and the degree of pre-lithiation α1 is computed using the following formula II:
$${α}_{1} = \frac{δ}{γ \cdot FG \cdot {ω}_{AM}} ; \qquad ( II )$$
wherein δ is a delithiation capacity per unit area of the active material-containing anode at the respective end-of-discharge voltage of the lithium-ion battery which has been further delithiated in a half-cell measurement against lithium;
wherein γ is a maximum capacity of the active material for lithium (corresponds to 4200 mAh/g for silicon with a stoichiometry of Li_{4,4}Si);
wherein FG is a surface weight of the anode coating in g/cm²; and
wherein ω_{AM} is a percentage weight fraction of active material in the anode coating.

30. The lithium-ion battery of claim 23, wherein the silicon-containing anode comprises silicon particles as active anode material.

31. The lithium-ion battery of claim 23, wherein the volume-weighted particle size distribution of the silicon particles is between the diameter percentiles d₁₀≥0.2 μm and d₉₀≤20.0 μm.
